(19) United States
(12) Patent Application Publication
(10) Pub. No.: US 2005/0036757 A1
(43) Pub. Date: Feb. 17, 2005

(54) Method for converting a video and/or an audio data flow

(76) Inventors: Alexander Romanowski, Hildesheim (DE); Stefan Lietz, Bad Salzdetfurth (DE)

Correspondence Address: Richard L Mayer;Kenyon & Kenyon, One Broadway, New York, NY, 10004, US

(21) Appl. No.: 10/489,995

(22) PCT Filed: Jul. 10, 2002
(86) PCT No.: PCT/DE02/02571

(30) Foreign Application Priority Data
Sep. 18, 2001 (DE) 101 46 036.8

(51) Int. Cl. H04N 7/00

(52) U.S. Cl. 386/46

(57) ABSTRACT

For converting an MPEG-2-compatible transport stream, it is separated into video and/or audio portions, as well as information that accompanies programs. The information that accompanies programs is converted into a DVD-compatible format and embedded in a DVD-compatible program stream together with the video and/or audio portions. This measure makes extended display possible in low-end terminals having only one base function.

### FIELD OF THE INVENTION

The present invention is directed to a method for converting a digital compressed video transport stream and/or an audio transport stream, according to the MPEG-2 (Moving Picture Experts Group) technology standard in particular, as it is used in a digital broadcasting system, for example.

### BACKGROUND INFORMATION

Devices, known as MPEG transcoders, which separate, process, and reassemble the MPEG transport stream in a different form, e.g., after modification of control bits or conversion of the bit rate, are known for converting MPEG transport streams. European Patent Application No. EP 11 04 198 describes such an MPEG transcoder. A method is known from German Patent Application No. DE 199 08 488 in which the packets of the desired program are selected from a DVD/MPEG transport stream via the PID (Proportional, Integral, Derivative) controllers.

### SUMMARY OF THE INVENTION

A method and a device according to the present invention make it possible to convert a digital compressed video transport stream and/or an audio transport stream, an MPEG-2 transport stream in particular, as is used in digital broadcast systems (DVB, DMB), for example, into a DVD-compatible MPEG-2 program stream, so that it is suited for replay on a terminal which has only one base function, an interconnected MPEG display, for example, and which was originally only designed to replay DVD data via a local network.

The present invention makes it possible to convert in a simple manner information or additional data which accompany programs, specific programs in particular, and which describe the content of the transport stream, into a DVD-compatible MPEG-2 program stream. Pieces of information which accompany programs in particular, and which, as “private stream,” are sometimes part of an MPEG-2 transport stream or an MPEG-2 program stream, may differ substantially in their composition. DVD compatibility is achievable using the principles according to the present invention.

In practice, there is relatively seldom any reason to interconvert MPEG-2 transport streams and MPEG-2 program streams. Exceptions are studio and transmission technologies, and the transmission of MPEG data streams via a network which prefers a certain MPEG format for reasons of its particular specification or better adaptation. Multimedia-capable buses in motor vehicles (MOST, IEEE1394 automotive) are named as examples. Such an MOST MPEG display should be particularly well suited for decoding DVD-compatible MPEG-2 program streams. Decoding of transport streams, e.g., during reception of digital broadcast systems (DVB, DMB), is optionally possible. However, this option is only achievable by involving additional hardware, thus incurring higher equipment costs. The present invention makes it possible to provide the MOST MPEG displays only with the required base function (in this case DVD-compatible MPEG-2 program stream decoding) and to implement additional functions at the signal source.

The MPEG-2 program stream resulting from the conversion according to the present invention fully corresponds, with regard to its format, to a program stream output by a networked DVD player.

Navigation through different programs and additional information may also take place in a manner compatible with the DVD replay equipment (DVD player). The actual source is signaled solely in a higher-level protocol via the identifiers of the individual devices connected within the network.

An advantage of the present invention is particularly represented by the fact that an expansion of a networked DVD player to transport stream-based contents (digital broadcast) solely means additional expense on the source side (receiver module), but none, however, on the sink side (MPEG display). Since, as a general rule, there are more sinks (displays) than signal sources (receiver modules) in such a networked system, this opens up a clear potential for cost reduction.

For implementing the information that accompanies programs it is advantageous according to the present invention to provide a menu generator which processes the information that accompanies programs, e.g., MPEG-PSI and DVG-SI, which are part of the received MPEG transport stream, in such a way that they may be embedded in a DVD-compatible manner in the resulting MPEG-2 program stream, as subpictures, for example. If necessary, the audio and/or video data must be converted into a format corresponding to the DVD specifications.

### BRIEF DESCRIPTION OF THE DRAWINGS

FIG. 1 shows a block diagram of a device for converting an MPEG-2 transport stream.

FIG. 2 shows a block diagram of a menu generator.

FIG. 3 shows a bus including connected terminals.

### DETAILED DESCRIPTION

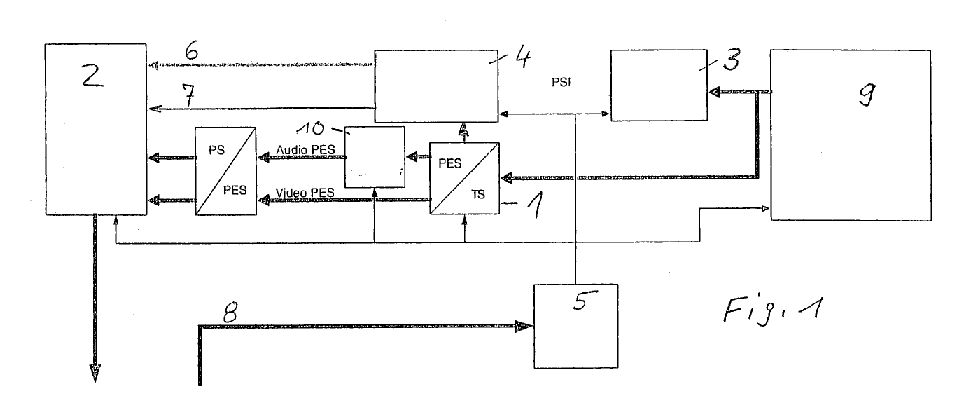

The method according to the present invention is used for converting a digitally compressed video and/or audio transport data stream, in particular according to the MPEG-2 standard, into a DVD-compatible program stream. Video and/or audio data, as well as data that accompanies programs, in particular data that describes programs, may be converted. Based upon the MPEG-2 system specification, the conversion takes place by separating the MPEG-2 transport stream into individual audio and video PES streams (Packetized Elementary Streams) using multiplexer 1 according to FIG. 1, and their subsequent multiplexing into a valid MPEG-2 program stream using multiplexer 2. The audio data contained in the MPEG-2 transport stream may, in rare cases, differ in sampling frequency, word width, and compression algorithm from that in a DVD-typical program stream. Therefore, an additional adaptor—format converter 3—is possibly necessary here prior to forming the program stream.

This audio data, as well as the video data, is processed on the level of the PES packets.

The information that accompanies or describes programs (MPEG-PSI, DVD-SI) contained in the transport stream is simultaneously separated using multiplexer 3 and is converted in such a way that, in line with the DVD specification, it may also be multiplexed into the resulting program stream using multiplexer 2.

In addition to audio and video data, MPEG-2 transport streams contain additional information that describes programs. The EPG (Electronic Program Guide) in DVB transmissions is an example of such information that describes programs.

This data, originally transmitted in the transport stream, must be able to be visualized or processed in the display unit in the terminal in a DVD-compatible manner. This is only possible in a DVD-conforming manner when it is multiplexed into the appropriate MPEG-2 program stream as “Presentation Control Information” or “Subpictures.” According to FIG. 3, a menu generator 4 undertakes the conversion of this data into a DVD-compatible data stream. If, by user request, program-describing information is to be displayed, menu generator 4 generates DVD-compatible menus from this information and feeds them to the network or system together with the program stream.

Menu generator 4 is also responsible for part of the interaction between the user and the signal source. While information about the programs contained is transmitted in MPEG-2 transport streams in the form of tables having different cross references, DVD-compatible program streams contain additional information, for instance about titles, languages, or subtitles, as complete menus. These are composed of a background, the menu data, and the highlight information. Therefore, processing the program-specific data contained in MPEG-2 transport streams into DVD-conforming menus is also the task of menu generator 4.

The modules necessary for the conversion—menu generator 4 and multiplexer 3—are controlled based upon user inputs (User Control Information 8) via control unit 5 and equipment-specific presettings. The permitted user inputs are part of the interactions permitted for the DVD replay. Control unit 5 controls modules 1, 2, 3, 4, 9, and 10.

A separate signaling channel for controlling menu generator 4 from at least one DVD-compatible terminal is advantageously provided for “User Control Information.”

As shown in FIG. 1, menu generator 4 generates two DVD-compatible bit streams 6 and 7, namely bit stream 6 according to the MPEG-2 standard made up of bitmaps, and another bit stream 7 for replay control, in particular for generating menus for the replay in a DVD-compatible terminal.

FIG. 1 shows an additional multiplexer 9 on the input side which is provided in particular to separate overhead information, e.g., for the interaction with multiplexer 2.

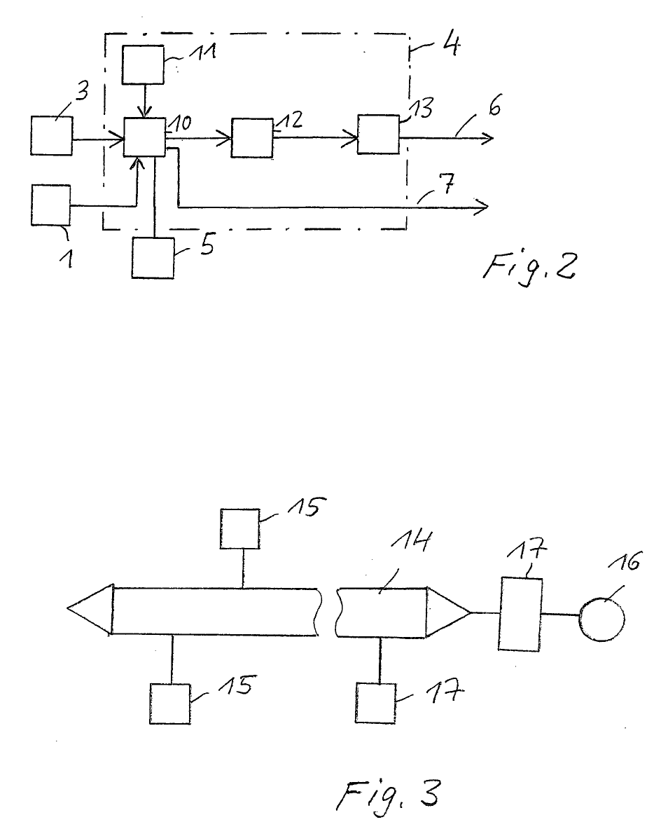

FIG. 2 shows the configuration of menu generator 4. Menu generator 4 is used to convert the information that accompanies programs contained in an MPEG-2 transport stream into DVD-compatible subpictures. This is MPEG-PSI (Program Specific Information) which is present in every MPEG-2 transport stream, and system-specific information of the transport power source such as DVB-SI (DVB System Information) or EPG (Electronic Program Guide) which is used only in certain systems and is sometimes optional.

While the information that accompanies programs of an MPEG-2 transport stream may be present in ASCII text format, for example, the subpictures of a DVD are always made up of sixteen-color bitmaps. These bitmaps must be present in compressed form and packed in a subpicture unit. In addition to the compressed bit map, the subpicture units are made up of a header and a display control sequence table. This table describes changes in the appearance of the bitmap during replay, for example color and contrast.

DVD-conforming presentation control information may optionally be generated in addition to the subpictures. This PCI contains, among other things, the highlight information using which individual parts of the total picture may be highlighted using different colors. This makes it possible to generate menus, e.g., for selecting a certain language or a certain program. The highlight information generated is transmitted in a stream—private stream 7—which is different from—subpictures private stream 6—.

From the information that accompanies programs of the MPEG-2 transport stream which it receives from multiplexer 3, bit map generator 10 generates bitmaps which are compatible with the DVD specification. For this purpose, it may, for example, access predefined bitmaps which are stored in memory 11, for example, and compile them into an overall bitmap depending on the material to be displayed. However, it may also compute the overall bitmap during run time. In addition to the bitmaps, bit map generator 10 may also generate DVD-compatible highlight information (private stream 7).

RUN length coder 12 compresses the bitmap according to the DVD specification.

Subpicture packer 13 generates a DVD-compatible subpicture unit from a compressed bit map, the header, and a display control sequence table. The subpicture unit is supplied to program stream multiplexer 2 via private stream 6.

FIG. 3 shows a bus 14 which is suited to transmit multimedia information. A digital compressed video and/or audio transport data stream, an MPEG-2 transport data stream, for example, is supplied from a signal source 16. At least some of terminals 15, connected to bus 14, should have only one base function, e.g., for receiving DVD-compatible MPEG-2 program streams. In order to make conversion into a DVD-compatible format unnecessary in each of terminals 15 connected to the bus, a device 17 according to the present invention, whose function and configuration were discussed earlier, is situated between signal source 16 and bus 14. For supplying to terminals 15, a branched network may of course be provided instead of a bus.

The present invention was explained so far only in connection with an MPEG standard. The method and the device may of course also be used for other image processing standards, e.g., MPEG-4, MPEG-7, involving modifications if needed.

1-12. (Canceled).

13. A method for converting at least one of a digital compressed video and audio data stream, the method comprising:
separating a transport stream into at least one of video and audio portions, and information that accompanies programs;
converting at least the information that accompanies programs into a DVD-compatible format; and
embedding the converted information that accompanies programs in a DVD-compatible program stream together with the at least one of video and audio portions.

14. The method according to claim 13, wherein the method is for converting the compressed data stream according to the MPEG-2 standard, as it is used in a digital broadcasting system.

15. The method according to claim 13, further comprising converting also the at least one of the video and audio portions if they are not present in the transport stream in a DVD-compatible format.

16. The method according to claim 13, further comprising feeding the DVD-compatible program stream into one of a network and a bus, to which a plurality of DVD-compatible terminals are connectable.

17. The method according to claim 13, further comprising embedding, in addition to the program—accompanying information of the transport stream, at least one of user-specific and device-specific information in the DVD-compatible program stream.

18. The method according to claim 13, further comprising multiplexing the information that accompanies programs and additional information into an MPEG program stream as one of “Presentation Control Information” and “Subpictures”.

19. A device for converting at least one of a digital compressed video and audio data transport stream, the device comprising:
at least one de-multiplexer unit for separating the at least one of video and audio data of the transport stream and information that accompanies programs;
a unit for converting the information that accompanies programs into a DVD-compatible format; and
a multiplexer unit, for embedding the converted information that accompanies programs together with the at least one of video and audio portions contained in the transport stream into a DVD-compatible program stream.

20. The device according to claim 19, wherein the device is for converting the compressed data transport stream according to the MPEG-2 standard.

21. The device according to claim 19, further comprising a format converter, and wherein the embedding is performed when the information is not already present in the DVD-compatible format.

22. The device according to claim 19, further comprising a menu generator for converting the information that accompanies programs into a DVD-compatible format, the menu generator having a bitmap generator for converting the information that accompanies programs into bitmaps.

23. The device according to claim 22, wherein the menu generator supplies first and second DVD-compatible bit streams, the first bit stream being composed of bitmaps according to the MPEG-2 standard and the second bit stream for a replay controller, for generating selection menus for a replay in a DVD-compatible terminal.

24. The device according to claim 22, further comprising a memory for predefined bitmaps assigned to the menu generator.

25. The device according to claim 23, further comprising a unit for compressing the bitmaps and a device for packing the compressed bitmaps into subpicture units according to a DVD standard assigned to the menu generator.

26. The device according to claim 23, wherein the menu generator inserts information about user-specific selection menus into the second bit stream.

27. The device according to claim 26, further comprising a separate signaling channel for controlling the menu generator with regard to a user-specific selection menu from at least one DVD-compatible terminal.

28. A system comprising:
a multimedia-capable bus;
terminals connectable to the bus, at least one of the terminals having only one base function;
at least one signal source supplying at least one of a digital compressed video and audio data stream which cannot be decoded via the base function of at least one of the terminals; and
a device for converting at least one of a digital compressed video and audio data transport stream, the device including:
at least one de-multiplexer unit for separating the at least one of video and audio data of the transport stream and information that accompanies programs,
a unit for converting the information that accompanies programs into a DVD-compatible format, and
a multiplexer unit, for embedding the converted information that accompanies programs together with the at least one of video and audio portions contained in the transport stream into a DVD-compatible program stream.

29. The system according to claim 28, wherein the at least one of the terminals having only one base function is for receiving DVD-compatible MPEG-2 program streams.
